(19) United States
(12) Patent Application Publication
(10) Pub. No.: US 2026/0018589 A1
(43) Pub. Date: Jan. 15, 2026

(54) ELECTROCHEMICAL DEVICE AND ELECTRONIC DEVICE

(71) Applicant: Ningde Amperex Technology Limited, Ningde (CN)

(72) Inventor: Songtao HU, Ningde (CN)

(73) Assignee: Ningde Amperex Technology Limited, Ningde (CN)

(21) Appl. No.: 19/331,581

(22) Filed: Sep. 17, 2025

Related U.S. Application Data
(63) Continuation of application No. PCT/CN2023/082222, filed on Mar. 17, 2023.

(51) Int. Cl. H01M 4/04; C25D 3/38; C25D 7/06; H01G 11/28; H01G 11/86; H01M 4/02; H01M 4/66; H01M 4/70

(52) U.S. Cl. CPC H01M 4/0452; C25D 3/38; C25D 7/0642; H01M 4/661; H01M 4/70; H01G 11/28; H01G 11/86; H01M 2004/027

(57) ABSTRACT

An electrochemical device includes a negative electrode sheet, the negative electrode sheet includes a negative electrode current collector and a negative electrode active material layer, and the negative electrode active material layer is located on the negative electrode current collector. The negative electrode current collector includes a copper foil, and a (220) crystal face peak area percentage of the copper foil is 15% to 21%. Using the copper foil with a (220) crystal face peak area percentage of 15% to 21% as the negative electrode current collector can increase the impact pass rate of the electrochemical device, thereby improving the safety performance of the electrochemical device.

### CROSS-REFERENCE TO RELATED APPLICATIONS

This application is a continuation application of International Application No. PCT/CN2023/082222, filed on Mar. 17, 2023, the content of which is incorporated herein by reference in its entirety.

### TECHNICAL FIELD

This application relates to the field of electrochemical energy storage, and specifically, to an electrochemical device and an electronic device.

### BACKGROUND

With the widespread application of electrochemical devices (for example, lithium-ion batteries) in various electronic products, users have raised increasingly high requirements for the safety performance of electrochemical devices. Therefore, further improvements are urgently needed to meet the users' increasingly high demands.

### SUMMARY

An embodiment of this application provides an electrochemical device. The electrochemical device includes a negative electrode sheet. The negative electrode sheet includes a negative electrode current collector and a negative electrode active material layer, where the negative electrode active material layer is located on the negative electrode current collector. The negative electrode current collector includes a copper foil, and a (220) crystal face peak area percentage of the copper foil is 15% to 21%.

In some embodiments, a (220) crystal face peak area percentage of the copper foil is 17% to 21%. In some embodiments, a crystal grain diameter of a surface of the copper foil is 1.7 μm to 3.5 μm. In some embodiments, a crystal grain diameter of a surface of the copper foil is 2.1 μm to 2.7 μm. In some embodiments, strength of the copper foil is greater than 400 MPa. In some embodiments, a thickness of the copper foil is 8 μm to 10 μm.

In some embodiments, the copper foil is obtained by electrodepositing an electrodeposition solution, and the electrodeposition solution includes copper sulfate, sulfuric acid, brightener, inhibitor, surfactant, and chloride ions. In some embodiments, the brightener includes at least one of sodium polydithiodipropane sulfonate, acetylthiourea, or allylthiourea. In some embodiments, the inhibitor includes at least one of gelatin or collagen. In some embodiments, the surfactant includes at least one of fatty alcohol, alkylphenol, fatty thiol, fatty amide, polyethylene glycol, or polysiloxane. In some embodiments, the electrodeposition solution meets at least one of the following conditions: a concentration of copper ions in the electrodeposition solution is 85 g/L to 95 g/L; a concentration of the sulfuric acid in the electrodeposition solution is 100 g/L to 110 g/L; or a concentration of the chloride ions in the electrodeposition solution is 10 mg/L to 80 mg/L. In some embodiments, the electrodeposition solution meets at least one of the following conditions: a concentration of the brightener in the electrodeposition solution is 10 mg/L to 60 mg/L; a concentration of the inhibitor in the electrodeposition solution is 5 mg/L to 60 mg/L; or a concentration of the surfactant in the electrodeposition solution is 1 mg/L to 10 mg/L.

An embodiment of this application provides an electronic device, including the foregoing electrochemical device.

In this application, using the copper foil with a (220) crystal face peak area percentage of 15% to 21% as the negative electrode current collector can increase the impact pass rate of the electrochemical device, thereby improving the safety performance of the electrochemical device.

### DETAILED DESCRIPTION

The following embodiments can help persons skilled in the art understand this application more comprehensively, but do not limit this application in any manner. An embodiment of this application provides an electrochemical device, and

the electrochemical device includes a negative electrode sheet. In some embodiments, the negative electrode sheet includes a negative electrode current collector and a negative electrode active material layer, and the negative electrode active material layer is located on the negative electrode current collector. In some embodiments, the negative electrode active material layer is located on at least one surface of the negative electrode current collector.

In some embodiments, the negative electrode current collector includes a copper foil, and a (220) crystal face peak area percentage of the copper foil is 15% to 21%. This type of copper foil, having high strength and high elongation, is conducive to increasing the impact pass rate of the electrochemical device, thereby improving the safety performance of the electrochemical device. This type of copper foil in this application, during the extrusion process of the electrode assembly of the electrochemical device, increases the elongation of the negative electrode current collector and has a large yield displacement, and during the compression process of the negative electrode sheet, can alleviate the fracture behavior of the electrode assembly and reduce the amount of debris, thus improving the mechanical safety performance of the electrochemical device.

In some embodiments, a (220) crystal face peak area percentage of the copper foil is 17% to 21%. Using the copper foil with a (220) crystal face peak area percentage of 17% to 21% allows for an elongation of above 9% of the copper foil and can significantly increase the impact pass rate of the electrochemical device, thereby improving the safety performance of the electrochemical device.

In some embodiments, a crystal grain diameter of a surface of the copper foil is 1.7 μm to 3.5 μm. Using the copper foil with a crystal grain diameter of 1.7 μm to 3.5 μm can improve strength and/or elongation of the copper foil. In some embodiments, a crystal grain diameter of a surface of the copper foil is 2.1 μm to 2.7 μm. This significantly improves the strength and elongation of the copper foil.

In some embodiments, strength of the copper foil is greater than 400 MPa. The high-strength copper foil can improve the structural stability of the negative electrode sheet. In some embodiments, a thickness of the copper foil is 8 μm to 10 μm. If the thickness of the copper foil is too small, the structural stability of the negative electrode sheet is affected; and if the thickness of the copper foil is too large, the energy density of the electrochemical device is affected.

In some embodiments, the copper foil is obtained by electrodepositing an electrodeposition solution, that is, the copper foil may include an electrolytic copper foil. In some embodiments, the electrodeposition solution used to prepare the electrolytic copper foil includes copper sulfate, sulfuric acid, brightener, inhibitor, surfactant, and chloride ions (Cl⁻). In some embodiments, the copper sulfate provides copper ions, and the sulfuric acid provides hydrogen ions. In some embodiments, Cl⁻ may be provided by hydrochloric acid. Cl⁻ and Cu⁺ can form CuCl, which accelerates the deposition rate and can also enhance brightness. In some embodiments, the brightener includes at least one of sodium polydithiodipropane sulfonate, acetylthiourea, or allylthiourea. The brightener enables growth rates of different crystal faces to tend to be consistent. In some embodiments, the inhibitor includes at least one of gelatin or collagen. The inhibitor can attach to high points of an electroplating substrate, inhibiting copper deposition at high points. In some embodiments, the surfactant includes at least one of fatty alcohol, alkylphenol, fatty thiol, fatty amide, polyethylene glycol, or polysiloxane. The surfactant can reduce surface tension, uniformly disperse Cu²⁺ ions, and exhibit a wetting effect.

In some embodiments, a concentration of copper ions in the electrodeposition solution is 85 g/L to 95 g/L. In some embodiments, a concentration of the sulfuric acid in the electrodeposition solution is 100 g/L to 110 g/L. In some embodiments, a concentration of the chloride ions in the electrodeposition solution is 10 mg/L to 80 mg/L. In some embodiments, the temperature of the electrodeposition solution is 40° C. to 60° C. during the electrolysis process. In some embodiments, the concentration of the brightener in the electrodeposition solution is 10 mg/L to 60 mg/L. In some embodiments, the concentration of the inhibitor in the electrodeposition solution is 5 mg/L to 60 mg/L. In some embodiments, the concentration of the surfactant in the electrodeposition solution is 1 mg/L to 10 mg/L.

In some embodiments, the negative electrode active material layer may include a negative electrode active material. In some embodiments, the negative electrode active material in the negative electrode active material layer includes at least one of graphite or a silicon-based material. In some embodiments, the silicon-based material includes at least one of silicon, a silicon-oxygen compound, a silicon-carbon compound, or a silicon alloy.

In some embodiments, the negative electrode active material layer may further include a conductive agent and/or a binder. In some embodiments, the conductive agent in the negative electrode active material layer may include at least one of carbon black, acetylene black, Ketjen black, lamellar graphite, graphene, carbon nanotubes, carbon fibers, or carbon nanowires. In some embodiments, the binder in the negative electrode active material layer may include at least one of carboxyl methyl cellulose (CMC), polyacrylic acid, a polyacrylate salt, polyacrylate, polyvinylpyrrolidone, polyaniline, polyimide, polyamideimide, polysiloxane, styrene-butadiene rubber, phenolic epoxy resin, polyester resin, polyurethane resin, or polyfluorene. It should be understood that the materials disclosed above are merely examples, and any other suitable material may be used for the negative electrode active material layer. In some embodiments, a mass ratio between the negative electrode active material, the conductive agent, and the binder in the negative electrode active material layer may be (80-99):(0.5-10):(0.5-10). It should be understood that this is merely an example and is not intended to limit this application.

In addition to the negative electrode sheet, the electrode assembly of the electrochemical device in this application may also include a positive electrode sheet, a separator disposed between the positive electrode sheet and the negative electrode sheet, and an electrolyte.

In some embodiments, the positive electrode sheet includes a positive electrode current collector and a positive electrode active material layer disposed on the positive electrode current collector. The positive electrode active material layer may be located on at least one surface of the positive electrode current collector. In some embodiments, the positive electrode current collector may be an aluminum foil, or may certainly be other positive electrode current collectors commonly used in the art. In some embodiments, the positive electrode current collector may have a thickness of 1 μm to 200 μm. In some embodiments, the positive electrode active material layer may be applied to only a partial region of the positive electrode current collector. In some embodiments, the positive electrode active material layer may have a thickness of 10 μm to 500 μm. It should be understood that this is merely an example, and any other suitable thickness may be adopted.

In some embodiments, the positive electrode active material layer includes a positive electrode active material. In some embodiments, the positive electrode active material includes LiCoO₂, LiNiO₂, LiMn₂O₄, LiCo_{1-y}M_{y}O₂, LiNi_{1-y}M_{y}O₂, LiMn_{2-y}M_{y}O₄, or LiNiₓCo_{y}Mn_{z}M_{1-x-y-z}O₂, where M is selected from at least one of Fe, Co, Ni, Mn, Mg, Cu, Zn, Al, Sn, B, Ga, Cr, Sr, V, or Ti, 0≤y≤1, 0≤x≤1, 0≤z≤1, and x+y+z≤1. In some embodiments, the positive electrode active material may include at least one of lithium cobaltate, lithium manganate, lithium iron phosphate, lithium iron manganese phosphate, lithium nickel cobalt manganate, lithium nickel cobalt aluminate, or lithium nickel manganate, and the positive electrode active material may undergo doping and/or coating processing.

In some embodiments, the positive electrode active material layer further includes a binder and a conductive agent. In some embodiments, the binder in the positive electrode active material layer may include at least one of polyvinylidene fluoride, a vinylidene fluoride-hexafluoropropylene copolymer, a styrene-acrylate copolymer, a styrene-butadiene copolymer, polyamide, polyacrylonitrile, polyacrylate, polyacrylic acid, a polyacrylate salt, carboxyl methyl cellulose, polyvinyl acetate, polyvinylpyrrolidone, polyvinyl ether, polymethyl methacrylate, polytetrafluoroethylene, or polyhexafluoropropylene. In some embodiments, the conductive agent in the positive electrode active material layer may include at least one of conductive carbon black, acetylene black, Ketjen black, lamellar graphite, graphene, carbon nanotubes, or carbon fibers. In some embodiments, a mass ratio between the positive electrode active material, the conductive agent, and the binder in the positive electrode active material layer may be (70-98):(1-15):(1-15). It should be understood that the descriptions above are merely examples, and any other suitable material, thickness, and mass ratio may be adopted for the positive electrode active material layer.

In some embodiments, the separator includes at least one of polyethylene, polypropylene, polyvinylidene fluoride, polyethylene terephthalate, polyimide, or aramid. For example, polyethylene is at least one selected from high-density polyethylene, low-density polyethylene, or ultrahigh-molecular-weight polyethylene. Especially, polyethylene and polypropylene have a good effect on preventing short circuits and can improve stability of a battery through a shutdown effect. In some embodiments, a thickness of the separator is in a range from about 3 μm to 500 μm.

In some embodiments, a surface of the separator may further include a porous layer. The porous layer is disposed on at least one surface of the separator. The porous layer includes at least one of inorganic particles or a binder. The inorganic particles are selected from at least one of aluminum oxide (Al₂O₃), silicon oxide (SiO₂), magnesium oxide (MgO), titanium oxide (TiO₂), hafnium dioxide (HfO₂), tin oxide (SnO₂), cerium dioxide (CeO₂), nickel oxide (NiO), zinc oxide (ZnO), calcium oxide (CaO), zirconium oxide (ZrO₂), yttrium oxide (Y₂O₃), silicon carbide (SiC), boehmite, aluminum hydroxide, magnesium hydroxide, calcium hydroxide, or barium sulfate. In some embodiments, pores of the separator have a diameter ranging from about 0.01 μm to 1 μm. The binder of the porous layer is selected from at least one of polyvinylidene fluoride, a vinylidene fluoride-hexafluoropropylene copolymer, polyamide, polyacrylonitrile, polyacrylate, polyacrylic acid, polyacrylate salt, carboxyl methyl cellulose, polyvinylpyrrolidone, polyvinyl ether, polymethyl methacrylate, polytetrafluoroethylene, or polyhexafluoropropylene. The porous layer on the surface of the separator can improve heat resistance, oxidation resistance, and electrolyte salt infiltration performance of the separator, and enhance adhesion between the separator and the electrode plates.

In some embodiments, the electrochemical device includes a lithium-ion battery. However, this application is not limited thereto. In some embodiments, the electrolyte includes at least one of fluoroether, fluoroethylene carbonate, or ether nitrile. In some embodiments, the electrolyte further includes a lithium salt. The lithium salt includes lithium bis(fluorosulfonyl)imide and lithium hexafluorophosphate. A concentration of the lithium salt ranges from 1 mol/L to 2 mol/L, and a mass ratio of the lithium bis(fluorosulfonyl)imide to the lithium hexafluorophosphate ranges from 0.06 to 5. In some embodiments, the electrolyte may further include a non-aqueous solvent. The non-aqueous solvent may be a carbonate compound, a carboxylate compound, an ether compound, another organic solvent, or a combination thereof.

The carbonate compound may be a linear carbonate compound, a cyclic carbonate compound, a fluorocarbonate compound, or a combination thereof.

An example of the linear carbonate compound is diethyl carbonate (DEC), dimethyl carbonate (DMC), dipropyl carbonate (DPC), methyl propyl carbonate (MPC), ethylene propyl carbonate (EPC), ethyl methyl carbonate (MEC), or a combination thereof. An example of the cyclic carbonate compound is ethylene carbonate (EC), propyl carbonate (PC), butyl carbonate (BC), vinyl ethyl carbonate (VEC), or a combination thereof. An example of the fluorocarbonate compound is fluoroethylene carbonate (FEC), 1,2-difluoroethylene carbonate, 1,1-difluoroethylene carbonate, 1,1,2-trifluoroethylene carbonate, 1,1,2,2-tetrafluoroethylene carbonate, 1-fluoro-2-methylethylene carbonate, 1-fluoro-1-methylethylene carbonate, 1,2-difluoro-1-methylethylene carbonate, 1,1,2-trifluoro-2-methylethylene carbonate, trifluoromethylethylene carbonate, or a combination thereof.

An example of the carboxylate compound is methyl acetate, ethyl acetate, n-propyl acetate, tert-butyl acetate, methyl propionate, ethyl propionate, propyl propionate, γ-butyrolactone, decanolide, valerolactone, mevalonolactone, caprolactone, methyl formate, or a combination thereof.

An example of the ether compound is dibutyl ether, tetraglyme, diglyme, 1,2-dimethoxyethane, 1,2-diethoxyethane, ethoxymethoxy ethane, 2-methyltetrahydrofuran, tetrahydrofuran, or a combination thereof.

An example of the another organic solvent is dimethyl sulfoxide, 1,2-dioxolane, sulfolane, methyl sulfolane, 1,3-dimethyl-2-imidazolidinone, N-methyl-2-pyrrolidone, formamide, dimethylformamide, acetonitrile, trimethyl phosphate, triethyl phosphate, trioctyl phosphate, phosphate ester, or a combination thereof.

In some embodiments of this application, an electrode assembly of the electrochemical device is a wound electrode assembly or a laminated electrode assembly. In some embodiments, the electrochemical device is a lithium-ion battery, but this application is not limited thereto.

In some embodiments of this application, a lithium-ion battery is used as an example. A positive electrode, a separator, and a negative electrode are wound or stacked in sequence to form an electrode assembly, and the electrode assembly is then packaged in an aluminum-plastic film, followed by injection of an electrolyte, formation, and packaging, so that the lithium-ion battery is prepared. Then, a performance test is performed on the prepared lithium-ion battery.

Those skilled in the art will understand that the method for preparing the electrochemical device (for example, the lithium-ion battery) described above is only an example. Without departing from the content disclosed in this application, other methods commonly used in the art may be used.

Some embodiments of this application provide an electronic device including the foregoing electrochemical device. The electronic device in some embodiments of this application is not particularly limited, and may be any known electronic device used in the prior art. In some embodiments, the electronic device may include but is not limited to a notebook computer, a pen-input computer, a mobile computer, an electronic book player, a portable telephone, a portable fax machine, a portable copier, a portable printer, a stereo headset, a video recorder, a liquid crystal television, a portable cleaner, a portable CD player, a mini-disc, a transceiver, an electronic notebook, a calculator, a storage card, a portable recorder, a radio, a standby power source, a motor, an automobile, a motorcycle, a motor bicycle, a bicycle, a lighting appliance, a toy, a game console, a clock, an electric tool, a flash lamp, a camera, a large household battery, or a lithium-ion capacitor.

Some specific examples and comparative examples are listed below to better describe this application, with lithium-ion batteries used as examples.

### Comparative Example 1

### Preparation of Lithium-Ion Battery

Preparation of positive electrode sheet: A positive electrode active material lithium cobaltateare, a conductive agent conductive carbon black, and a binder polyvinylidene fluoride (PVDF) were dissolved in an N-methylpyrrolidone (NMP) solution at a weight ratio 97.9:0.9:1.2, to obtain a positive electrode slurry. A 13 μm aluminum foil was used as a positive electrode current collector, and the positive electrode slurry was applied to the positive electrode current collector. Drying, cold calendering, and cutting were performed to obtain a positive electrode sheet. A compacted density of the positive electrode sheet was 4.15 g/cm³.

Preparation of negative electrode sheet: A copper foil had a thickness of 9 μm, and an electrodeposition solution for electrodepositing the copper foil included copper sulfate, sulfuric acid, and hydrochloric acid. The copper sulfate provided copper ions, the sulfuric acid provided hydrogen ions, and the hydrochloric acid provided chloride ions. A concentration of the copper ions in the electrodeposition solution was 91 g/L, a content of the sulfuric acid was 105 g/L, a concentration of the chloride ions was 30 mg/L, and an electrodeposition temperature was 55° C. For further details of the process conditions, refer to Table 1.

A negative electrode active material artificial graphite, a binder styrene-butadiene rubber (SBR), and a thickener carboxyl methyl cellulose (CMC) were dissolved in deionized water at a weight ratio of 97.4:1.4:1.2, to form a negative electrode slurry. The copper foil was used as a negative electrode current collector, and the negative electrode slurry was applied to the negative electrode current collector, followed by drying, cold calendering, and cutting, to obtain a negative electrode. A compacted density of the negative electrode was 1.8 g/cm³.

Preparation of separator: Polyethylene (PE) with a thickness of 5 μm was used as a separator substrate, two sides of the separator substrate were each coated with a 2 μm aluminum oxide ceramic layer, and ultimately two sides of the ceramic layer were each coated with a 2.5 mg binder polyvinylidene fluoride (PVDF), followed by drying.

Preparation of electrolyte: In an environment with a water content of less than 10 ppm, ethylene carbonate (EC for short), propylene carbonate (PC for short), diethyl carbonate (DEC for short), ethyl propionate (EP for short), and propyl propionate (PP for short) were mixed well at a mass ratio of 1:1:1:1:1. Then, lithium salt LiPF₆ (final concentration of 1.15 mol/L) was dissolved in this non-aqueous solvent to obtain an electrolyte.

Preparation of lithium-ion battery: The positive electrode sheet, the separator, and the negative electrode sheet were stacked in sequence, with the separator sandwiched between the positive electrode sheet and the negative electrode sheet for separation, and wound to obtain an electrode assembly. The electrode assembly was put in an outer package aluminum-plastic film, and was dehydrated at 80° C. Then, the foregoing electrolyte was injected and the package was sealed, followed by processes such as formation, degassing, and trimming to obtain a lithium-ion battery.

The parameter difference between Comparative examples 2 to 4, Examples 1 to 11, and Comparative example 1 lay in the process condition of the electrodeposited copper foil, as detailed in Table 1.

The following describes methods for testing parameters of this application.

### (220) Crystal Face Texture Test:

The preferred orientation of the crystal face was characterized by the peak area percentage of the crystal face index (hkl):

$${M}_{( 220 ) =} {S}_{( 220 )} / ( {S}_{( 220 ) +} {S}_{( 111 ) +} {S}_{( 200 )} )$$

where M(220) was the (220) crystal face peak area percentage, S(220) was the (220) crystal face peak area, S(111) was the (111) crystal face peak area, and S(200) was the (200) crystal face peak area.

The above were tested using XRD (X-ray diffraction), and the crystal face index (hkl) represented a set of parallel crystal faces with an equal spacing therebetween. Only intercepts of any crystal face with three crystal axes were required. The reciprocals were taken and multiplied by the least common multiple, and smallest (coprime) integers obtained were enclosed in parentheses, representing the crystal face index.

The crystal grain diameter might be calculated according to this formula:

$$D = K λ / β cos θ$$

where K was the Scherrer constant, with a value of 1; λ was the X-ray wavelength, which was 0.15405 nm for a Cu target; β (in radians) was the true integral breadth of the diffraction peak after subtraction of the instrumental broadening; and θ was the Bragg angle.

### Strength Test:

The copper foil was cut into copper foil samples with a width of 12.7 mm and a length greater than 50 mm in both transverse and longitudinal directions using a die cutter, ensuring that the samples were burr-free and flat. The copper foil samples were tightly fixed to fixing clamps of the tensile testing machine and tightened, ensuring that the samples were flat without skew. The tensile testing machine model was Instron 3365. After the copper foil material was selected, the tensile testing machine switch was turned on. The tensile testing machine pulled the copper foil samples, displaying displacement and force curves. The maximum force/sectional area from the start of stretching to the final fracture was defined as the tensile strength. P=F/S, where P was the tensile strength, F was the maximum force, and S was the sectional area of the copper foil sample.

### Elongation Test:

The copper foil was cut into copper foil samples with a width of 12.7 mm and a length greater than 50 mm in both transverse and longitudinal directions using a die cutter, ensuring that the samples were burr-free and flat. The copper foil samples were tightly fixed to fixing clamps of the tensile testing machine and tightened, ensuring that the samples were flat without skew. The tensile testing machine model was Instron 3365. After the copper foil material was selected, the tensile testing machine switch was turned on. The tensile testing machine pulled the copper foil samples, displaying displacement and force curves. A ratio of the deformation amount ΔL from the start of stretching to the final fracture to the initial distance L between clamping heads was defined as the elongation.

S=ΔL/L, where S was the elongation, ΔL was the deformation amount from the start of stretching to the final fracture, and L was the initial distance L between clamping heads.

### Impact Pass Rate Test:

1. Voltage and State of charge (SOC) before impact were respectively 4.5 V and 100%.
2. The appearance was checked and photographed before and after the test.
3. A temperature sensing wire was stuck.
4. In a test environment of 20±5° C., the sample was placed on a test bench, and a 15.8 mm diameter round bar was positioned at the center of the wide surface of the sample, the round bar being perpendicular to the long axis of the sample. A 9.1±0.1 kg hammer was dropped vertically from a height of 610±25 mm in a free state, hitting the intersection of the round bar and the sample.
5. Measurement frequency: Voltage and internal resistance were measured using 1 kHz specifications after pretreatment and after the test.
6. Judgment criteria: No fire and no explosion.

Table 1 shows parameters and evaluation results of Examples 1 to 10 and Comparative examples 1 to 4.

TABLE 1

| | | (220) Crystal | Crystal | | | |
|---|---|---|---|---|---|---|
| | | face peak | grain | | | Impact |
| | Process condition for preparing | area | diameter | Strength | | pass |
| | copper foil | percentage/% | (μm) | (MPa) | Elongation | rate |
| Comparative | 1. Sodium polydithiodipropane | 10 | 2.6 | 460 | 4.20% | 85% |
| example 1 | sulfonate:acetylthiourea = 0:100; | | | | | |
| | total concentration = 10 mg/L. | | | | | |
| | 2. Gelatin:collagen = 30:70; total | | | | | |
| | concentration = 10 mg/L. | | | | | |
| | 3. Chloride ion concentration: 30 mg/L. | | | | | |
| | 4. Surfactant: fatty | | | | | |
| | alcohol:alkylphenol = 20:80; total | | | | | |
| | concentration = 3 mg/L. | | | | | |
| | 5. Copper ion concentration: 91 g/L. | | | | | |
| | 6. Acid concentration: 105 g/L. | | | | | |
| | 7. Electrodeposition solution | | | | | |
| | temperature: 55° C. | | | | | |
| Comparative | 1. Sodium polydithiodipropane | 13 | 2.6 | 445 | 5.10% | 91% |
| example 2 | sulfonate:acetylthiourea = 10:90; | | | | | |
| | total concentration = 10 mg/L. | | | | | |
| | 2. Gelatin:collagen = 30:70; total | | | | | |
| | concentration = 10 mg/L. | | | | | |
| | 3. Chloride ion concentration: 30 mg/L. | | | | | |
| | 4. Surfactant: fatty | | | | | |
| | alcohol:alkylphenol = 20:80; total | | | | | |
| | concentration = 3 mg/L. | | | | | |
| | 5. Copper ion concentration: 91 g/L. | | | | | |
| | 6. Acid concentration: 105 g/L. | | | | | |
| | 7. Electrodeposition solution | | | | | |
| | temperature: 55° C. | | | | | |
| Example 1 | 1. Sodium polydithiodipropane | 15 | 2.6 | 410 | 8.10% | 95% |
| | sulfonate:acetylthiourea = 20:80; | | | | | |
| | total concentration = 10 mg/L. | | | | | |
| | 2. Gelatin:collagen = 30:70; total | | | | | |
| | concentration = 10 mg/L. | | | | | |
| | 3. Chloride ion concentration: 30 mg/L. | | | | | |
| | 4. Surfactant: fatty | | | | | |
| | alcohol:alkylphenol = 20:80; total | | | | | |
| | concentration = 3 mg/L. | | | | | |
| | 5. Copper ion concentration: 91 g/L. | | | | | |
| | 6. Acid concentration: 105 g/L. | | | | | |
| | 7. Electrodeposition solution | | | | | |
| | temperature: 55° C. | | | | | |
| Example 2 | 1. Sodium polydithiodipropane | 17 | 2.6 | 407 | 9.30% | 98% |
| | sulfonate:acetylthiourea = 25:75; | | | | | |
| | total concentration = 10 mg/L. | | | | | |
| | 2. Gelatin:collagen = 30:70; total | | | | | |
| | concentration = 10 mg/L. | | | | | |
| | 3. Chloride ion concentration: 25 mg/L. | | | | | |
| | 4. Surfactant: fatty | | | | | |
| | alcohol:alkylphenol = 20:80; total | | | | | |
| | concentration = 3 mg/L. | | | | | |
| | 5. Copper ion concentration: 91 g/L. | | | | | |
| | 6. Acid concentration: 105 g/L. | | | | | |
| | 7. Electrodeposition solution | | | | | |
| | temperature: 55° C. | | | | | |
| Example 3 | 1. Sodium polydithiodipropane | 19 | 2.6 | 400 | 9.80% | 98% |
| | sulfonate:acetylthiourea = 30:70; | | | | | |
| | total concentration = 10 mg/L. | | | | | |
| | 2. Gelatin:collagen = 30:70; total | | | | | |
| | concentration = 10 mg/L. | | | | | |
| | 3. Chloride ion concentration: 25 mg/L. | | | | | |
| | 4. Surfactant: fatty | | | | | |
| | alcohol:alkylphenol = 20:80; total | | | | | |
| | concentration = 3 mg/L. | | | | | |
| | 5. Copper ion concentration: 91 g/L. | | | | | |
| | 6. Acid concentration: 105 g/L. | | | | | |
| | 7. Electrodeposition solution | | | | | |
| | temperature: 55° C. | | | | | |
| Example 4 | 1. Sodium polydithiodipropane | 21 | 2.6 | 385 | 10.50% | 97% |
| | sulfonate:acetylthiourea = 35:65; | | | | | |
| | total concentration = 10 mg/L. | | | | | |
| | 2. Gelatin:collagen = 30:70; total | | | | | |
| | concentration = 10 mg/L. | | | | | |
| | 3. Chloride ion concentration: 25 mg/L. | | | | | |
| | 4. Surfactant: fatty | | | | | |
| | alcohol:alkylphenol = 20:80; total | | | | | |
| | concentration = 3 mg/L. | | | | | |
| | 5. Copper ion concentration: 91 g/L. | | | | | |
| | 6. Acid concentration: 105 g/L. | | | | | |
| | 7. Electrodeposition solution | | | | | |
| | temperature: 55° C. | | | | | |
| Comparative | 1. Sodium polydithiodipropane | 23 | 2.6 | 415 | 6.00% | 92% |
| example 3 | sulfonate:acetylthiourea = 45:55; | | | | | |
| | total concentration = 10 mg/L. | | | | | |
| | 2. Gelatin:collagen = 30:70; total | | | | | |
| | concentration = 10 mg/L. | | | | | |
| | 3. Chloride ion concentration: 25 mg/L. | | | | | |
| | 4. Surfactant: fatty | | | | | |
| | alcohol:alkylphenol = 20:80; total | | | | | |
| | concentration = 3 mg/L. | | | | | |
| | 5. Copper ion concentration: 91 g/L. | | | | | |
| | 6. Acid concentration: 105 g/L. | | | | | |
| | 7. Electrodeposition solution | | | | | |
| | temperature: 55° C. | | | | | |
| Comparative | 1. Sodium polydithiodipropane | 25 | 2.6 | 425 | 5.80% | 90% |
| example 4 | sulfonate:acetylthiourea = 55:45; | | | | | |
| | total concentration = 10 mg/L. | | | | | |
| | 2. Gelatin:collagen = 30:70; total | | | | | |
| | concentration = 10 mg/L. | | | | | |
| | 3. Chloride ion concentration: 25 mg/L. | | | | | |
| | 4. Surfactant: fatty | | | | | |
| | alcohol:alkylphenol = 20:80; total | | | | | |
| | concentration = 3 mg/L. | | | | | |
| | 5. Copper ion concentration: 91 g/L. | | | | | |
| | 6. Acid concentration: 105 g/L. | | | | | |
| | 7. Electrodeposition solution | | | | | |
| | temperature: 55° C. | | | | | |
| Example 5 | 1. Sodium polydithiodipropane | 18 | 1.7 | 435 | 6.10% | 93% |
| | sulfonate:acetylthiourea = 25:75; | | | | | |
| | total concentration = 20 mg/L. | | | | | |
| | 2. Gelatin:collagen = 30:70; total | | | | | |
| | concentration = 10 mg/L. | | | | | |
| | 3. Chloride ion concentration: 25 mg/L. | | | | | |
| | 4. Surfactant: fatty | | | | | |
| | alcohol:alkylphenol = 20:80; total | | | | | |
| | concentration = 3 mg/L. | | | | | |
| | 5. Copper ion concentration: 91 g/L. | | | | | |
| | 6. Acid concentration: 105 g/L. | | | | | |
| | 7. Electrodeposition solution | | | | | |
| | temperature: 55° C. | | | | | |
| Example 6 | 1. Sodium polydithiodipropane | 18 | 2.1 | 420 | 6.90% | 95% |
| | sulfonate:acetylthiourea = 25:75; | | | | | |
| | total concentration = 15 mg/L. | | | | | |
| | 2. Gelatin:collagen = 30:70; total | | | | | |
| | concentration = 10 mg/L. | | | | | |
| | 3. Chloride ion concentration: 25 mg/L. | | | | | |
| | 4. Surfactant: fatty | | | | | |
| | alcohol:alkylphenol = 20:80; total | | | | | |
| | concentration = 3 mg/L. | | | | | |
| | 5. Copper ion concentration: 91 g/L. | | | | | |
| | 6. Acid concentration: 105 g/L. | | | | | |
| | 7. Electrodeposition solution | | | | | |
| | temperature: 55° C. | | | | | |
| Example 7 | 1. Sodium polydithiodipropane | 18 | 2.6 | 405 | 9.50% | 98% |
| | sulfonate:acetylthiourea = 25:75; | | | | | |
| | total concentration = 10 mg/L. | | | | | |
| | 2. Gelatin:collagen = 30:70; total | | | | | |
| | concentration = 10 mg/L. | | | | | |
| | 3. Chloride ion concentration: 25 mg/L. | | | | | |
| | 4. Surfactant: fatty | | | | | |
| | alcohol:alkylphenol = 20:80; total | | | | | |
| | concentration = 3 mg/L. | | | | | |
| | 5. Copper ion concentration: 91 g/L. | | | | | |
| | 6. Acid concentration: 105 g/L. | | | | | |
| | 7. Electrodeposition solution | | | | | |
| | temperature: 55° C. | | | | | |
| Example 8 | 1. Sodium polydithiodipropane | 18 | 2.7 | 400 | 9.60% | 97% |
| | sulfonate:acetylthiourea = 25:75; | | | | | |
| | total concentration = 8 mg/L. | | | | | |
| | 2. Gelatin:collagen = 30:70; total | | | | | |
| | concentration = 10 mg/L. | | | | | |
| | 3. Chloride ion concentration: 25 mg/L. | | | | | |
| | 4. Surfactant: fatty | | | | | |
| | alcohol:alkylphenol = 20:80; total | | | | | |
| | concentration = 3 mg/L. | | | | | |
| | 5. Copper ion concentration: 91 g/L. | | | | | |
| | 6. Acid concentration: 105 g/L. | | | | | |
| | 7. Electrodeposition solution | | | | | |
| | temperature: 55° C. | | | | | |
| Example 9 | 1. Sodium polydithiodipropane | 18 | 3.2 | 385 | 9.7% | 93% |
| | sulfonate:acetylthiourea = 25:75; | | | | | |
| | total concentration = 5 mg/L. | | | | | |
| | 2. Gelatin:collagen = 30:70; total | | | | | |
| | concentration = 10 mg/L. | | | | | |
| | 3. Chloride ion concentration: 25 mg/L. | | | | | |
| | 4. Surfactant: fatty | | | | | |
| | alcohol:alkylphenol = 20:80; total | | | | | |
| | concentration = 3 mg/L. | | | | | |
| | 5. Copper ion concentration: 91 g/L. | | | | | |
| | 6. Acid concentration: 105 g/L. | | | | | |
| | 7. Electrodeposition solution | | | | | |
| | temperature: 55° C. | | | | | |
| Example 10 | 1. Sodium polydithiodipropane | 18 | 3.5 | 385 | 9.8% | 93% |
| | sulfonate:acetylthiourea = 25:75; | | | | | |
| | total concentration = 2 mg/L. | | | | | |
| | 2. Gelatin:collagen = 30:70; total | | | | | |
| | concentration = 10 mg/L. | | | | | |
| | 3. Chloride ion concentration: 25 mg/L. | | | | | |
| | 4. Surfactant: fatty | | | | | |
| | alcohol:alkylphenol = 20:80; total | | | | | |
| | concentration = 3 mg/L. | | | | | |
| | 5. Copper ion concentration: 91 g/L. | | | | | |
| | 6. Acid concentration: 105 g/L. | | | | | |
| | 7. Electrodeposition solution | | | | | |
| | temperature: 55° C. | | | | | |

It can be known through comparison between examples 1 to 4 and Comparative examples 1 to 4 that using a copper foil with a (220) crystal face peak area percentage of 15% to 21% as the negative electrode current collector ensures high strength and high elongation of the negative electrode current collector, which increases the impact pass rate of the lithium-ion battery, thereby improving the safety performance of the lithium-ion battery. The (220) crystal face peak area percentage of the copper foil is too high or too low, which is not conducive to increasing the elongation of the copper foil and increasing the impact pass rate of the lithium-ion battery. In addition, when the (220) crystal face peak area percentage of the copper foil is 17% to 21%, the effect of increasing the impact pass rate of the lithium-ion battery is more significant.

It can be known through comparison between Examples 5 to 10 that using a copper foil with a crystal grain diameter of 1.7 μm to 3.5 μm is conducive to ensuring high strength and high elongation of the negative electrode current collector and to increasing the impact pass rate of the lithium-ion battery, thus improving the safety performance of the lithium-ion battery.

The foregoing descriptions are merely preferred examples of this application and explanations of the technical principles used. Persons skilled in the art should understand that the related scope disclosed in this application is not limited to the technical solutions formed by a specific combination of the foregoing technical characteristics, and should also cover other technical solutions formed by any combination of the foregoing technical characteristics or their equivalent characteristics. For example, the technical solution formed by replacement between the foregoing features and technical features having similar functions disclosed in this application.

What is claimed is:

1. An electrochemical device, comprising:
a negative electrode sheet, wherein the negative electrode sheet comprises a negative electrode current collector and a negative electrode active material layer, and the negative electrode active material layer is located on the negative electrode current collector;
wherein the negative electrode current collector comprises a copper foil, and a (220) crystal face peak area percentage of the copper foil is 15% to 21%.

2. The electrochemical device according to claim 1, wherein the (220) crystal face peak area percentage of the copper foil is 17% to 21%.

3. The electrochemical device according to claim 1, wherein a crystal grain diameter of a surface of the copper foil is 1.7 μm to 3.5 μm.

4. The electrochemical device according to claim 1, wherein a crystal grain diameter of a surface of the copper foil is 2.1 μm to 2.7 μm.

5. The electrochemical device according to claim 1, wherein strength of the copper foil is greater than 400 MPa.

6. The electrochemical device according to claim 1, wherein a thickness of the copper foil is 8 μm to 10 μm.

7. The electrochemical device according to claim 1, wherein the copper foil is an electrodeposited copper foil.

8. A method for preparing an copper foil, wherein the copper foil formed by electrodepositing an electrodeposition solution, and the electrodeposition solution comprises copper sulfate, sulfuric acid, brightener, inhibitor, surfactant, and chloride ions;
the brightener comprises at least one of sodium polydithiodipropane sulfonate, acetylthiourea, or allylthiourea;
the inhibitor comprises at least one of gelatin or collagen; and
the surfactant comprises at least one of fatty alcohol, alkylphenol, fatty thiol, fatty amide, polyethylene glycol, or polysiloxane.

9. The method according to claim 8, wherein the electrodeposition solution meets at least one of the following conditions:
a concentration of copper ions in the electrodeposition solution is 85 g/L to 95 g/L;
a concentration of the sulfuric acid in the electrodeposition solution is 100 g/L to 110 g/L; or
a concentration of the chloride ions in the electrodeposition solution is 10 mg/L to 80 mg/L.

10. The method according to claim 8, wherein the electrodeposition solution meets at least one of the following conditions:
a concentration of the brightener in the electrodeposition solution is 10 mg/L to 60 mg/L;
a concentration of the inhibitor in the electrodeposition solution is 5 mg/L to 60 mg/L; or
a concentration of the surfactant in the electrodeposition solution is 1 mg/L to 10 mg/L.

11. An electronic device, comprising an electrochemical device, the electrochemical device, comprising:
a negative electrode sheet, wherein the negative electrode sheet comprises a negative electrode current collector and a negative electrode active material layer, and the negative electrode active material layer is located on the negative electrode current collector;
wherein the negative electrode current collector comprises a copper foil, and a (220) crystal face peak area percentage of the copper foil is 15% to 21%.

12. The electronic device according to claim 11, wherein the (220) crystal face peak area percentage of the copper foil is 17% to 21%.

13. The electronic device according to claim 11, wherein a crystal grain diameter of a surface of the copper foil is 1.7 μm to 3.5 μm.

14. The electronic device according to claim 11, wherein a crystal grain diameter of a surface of the copper foil is 2.1 μm to 2.7 μm.

15. The electronic device according to claim 11, wherein strength of the copper foil is greater than 400 MPa.

16. The electronic device according to claim 11, wherein a thickness of the copper foil is 8 μm to 10 μm.

17. The electronic device according to claim 11, wherein the copper foil is an electrodeposited copper foil.
